(19) United States
(12) Patent Application Publication
(10) Pub. No.: US 2006/0166581 A1
(43) Pub. Date: Jul. 27, 2006

(54) Woven, lateral direction ventilated wall board structure

(76) Inventor: Tsu-Ming Huang, Chang Hwa Hsien (TW)

Correspondence Address: TROXELL LAW OFFICE PLLC, SUITE 1404, 5205 LEESBURG PIKE, FALLS CHURCH, VA, 22041, US

(21) Appl. No.: 11/041,964

(22) Filed: Jan. 26, 2005

(51) Int. Cl. D03D 15/00; B32B 5/26; D04B 21/00

(52) U.S. Cl. 442/181; 442/239; 442/304

(57) ABSTRACT

A woven, lateral direction ventilated wall board structure consisting of top and bottom, double-sided knit cloth surfaces conjoined in the center section by numerous densely distributed, straightly arrayed, stiff, supportive monofilament into a pad of a certain thickness. A liquid adhesive agent (such as a sound absorbent agent, inflammable agent, or stitch bonding agent) is applied onto the cloth surfaces of the board structure as a treatment and after the adhesive agent evenly permeates the weave crevices of the fabric and dries, since the fabric weave is filled-in—enabling the fabric to meet flat or curved surface requirements, it hardens into a board-like entity that provides for a horizontal ceiling or a vertical wall surface installed over interior layers. Since aeration spaces are distributed between the strands of monofilament at the center section of the pad that, in conjunction with a laterally installed air current exhaust/intake device, serve as hidden passageways for the outward discharge and dispersal of hot air currents accumulated inside, the present invention achieves active heat dissipation for indoor temperature reduction. Since the board structure can be translucent, the invention herein decreases the daytime use of electrical lighting to thereby effectively save energy resources. Furthermore, conductive strands are woven into portions of the cloth surfaces that are distributed and in continuity, providing for the full coverage wiring of lighting rods and ground wires to thereby enhance large-scale building safety, which are among the features of the invention herein.

### BACKGROUND OF THE INVENTION

1) Field of the Invention

The invention herein relates to a woven, lateral direction ventilated wall board structure that replaces various hard board materials of plastic extrusion or concentration process fabrication that consists of top and bottom, double-sided knit cloth surfaces conjoined in the center section by numerous densely distributed, straightly arrayed, stiff, and supportive monofilament into a pad of a certain thickness. A liquid adhesive agent (such as a sound absorbent agent, inflammable agent, or stitch bonding agent) is applied onto the cloth surfaces of the board structure as a treatment and after the adhesive agent evenly permeates the weave crevices of the fabric and dries, since the fabric weave is filled-in, it hardens into a board-like entity that provides for a horizontal ceiling or a vertical wall surface installed over interior layers. Since aeration spaces are distributed between the strands of monofilament at the center section of the pad, the present invention achieves heat dissipation and temperature reduction and, furthermore, can be translucent with conductive strands distributively woven into the cloth surfaces.

2) Description of the Prior Art

In addition to utilization as the basic materials for the construction of indoor horizontal or vertical wall surfaces, conventional brick, concrete, and steel frame panels, etc. also mainly serve as a direct means or interior surface overlay for insulation, fireproofing, sound absorption, or enhancing appearance. Such wall boards are typically contiguous materials fabricated by plastic extrusion (or the integration of insulated, sound absorbent, or fireproof materials) or single-piece board materials fabricated by a concentration or compressive conjoinment process (or the integration of insulating, sound absorbent, or fireproof materials). In addition to being unusable as a curved surface when such a surface is required for construction, the resulting hard structure is not translucent such that when utilized as a ceiling, due to rather dim conditions in the indoor space (such as a gymnasium or large-scale hall), electrical lighting still has be to utilized in the daytime, resulting in considerable energy waste, especially as such basic materials utilize materials or integrated materials that characteristically do not readily retain heat that facilitates hot air dispersion; or, crevices are meticulously left in between the material utilized to provide for heated air current flow to achieve “passive” heat dissipation and thereby effectively reduce temperature. However, the actual heat dissipation capacity of such structures is rather limited, especially in muggy and windless high-temperature conditions, wherein due to high temperature outdoors, indoor high temperature is very difficult to disperse externally and adjust, requiring the wasting of a large volume of electric current for air conditioners that directly lower the temperature, which is uneconomical and not in compliance with environmental protection.

### SUMMARY OF THE INVENTION

The primary objective of the invention herein is to provide a woven, lateral direction ventilated wall board structure consisting of top and bottom, double-sided knit cloth surfaces conjoined in the center section by numerous densely distributed, straightly arrayed, stiff, and supportive monofilament into a pad of a certain thickness that provides for a horizontal ceiling or a vertical wall surface installed over interior layers; since aeration spaces are distributed between the strands of monofilament at the center section of the pad that, in conjunction with a laterally installed air current exhaust/intake device, serve as hidden passageways for the outward discharge and dispersal of hot air currents which accumulate inside, the present invention achieves “active” heat dissipation for optimized indoor temperature reduction.

Another objective of the invention herein is to provide a woven, lateral direction ventilated wall board structure, wherein a liquid adhesive agent (such as a sound absorbent agent, inflammable agent, or stitch bonding agent) is applied onto the cloth surfaces of the board structure as a treatment and after the adhesive agent evenly permeates the weave crevices of the fabric and dries, since the fabric weave is filled-in, it hardens into a board-like entity, enabling the fabric to meet flat or curved surface requirements for the accurate and convenient interior layer installation of a horizontal ceiling or a vertical wall surface; the top and bottom, double-sided knit cloth surfaces are conjoined in the center section by densely distributed, straightly arrayed, stiff, translucent, and supportive monofilament into a pad such that it is partially translucent to effectively reduce dim conditions indoors under ceilings, decreasing the need to use electrical lighting during the daytime and thereby effectively saving energy resources, which is among the features of the invention herein.

Yet another objective of the invention herein is to provide a woven, lateral direction ventilated wall board structure, wherein the top and bottom, double-sided knit cloth surfaces of the pad have conductive strands woven into portions of it that are distributed and in continuity and, as such, provides for the full coverage wiring of lighting rods and ground wires to thereby enhance large-scale building safety, which is among the features of the invention herein.

### BRIEF DESCRIPTION OF THE DRAWINGS

FIG. 1 is an isometric drawing of the invention herein.

FIG. 1-A is an isometric drawing of the numerous parts of the invention herein.

FIG. 1-B is an isometric drawing of the invention herein that shows the surfaces on which adhesive is applied.

FIG. 2 is an isometric drawing of an embodiment of the invention herein.

FIG. 2-A is a cross-sectional drawing of an embodiment of the invention herein that illustrates the temperature reduction process.

FIG. 2-B is a partially magnified drawing of FIG. 2.

FIG. 3 is an isometric drawing of the sound absorption board of the invention herein.

FIG. 3-A is an orthographic drawing of the layout of FIG. 3.

### DETAILED DESCRIPTION OF THE PREFERRED EMBODIMENTS

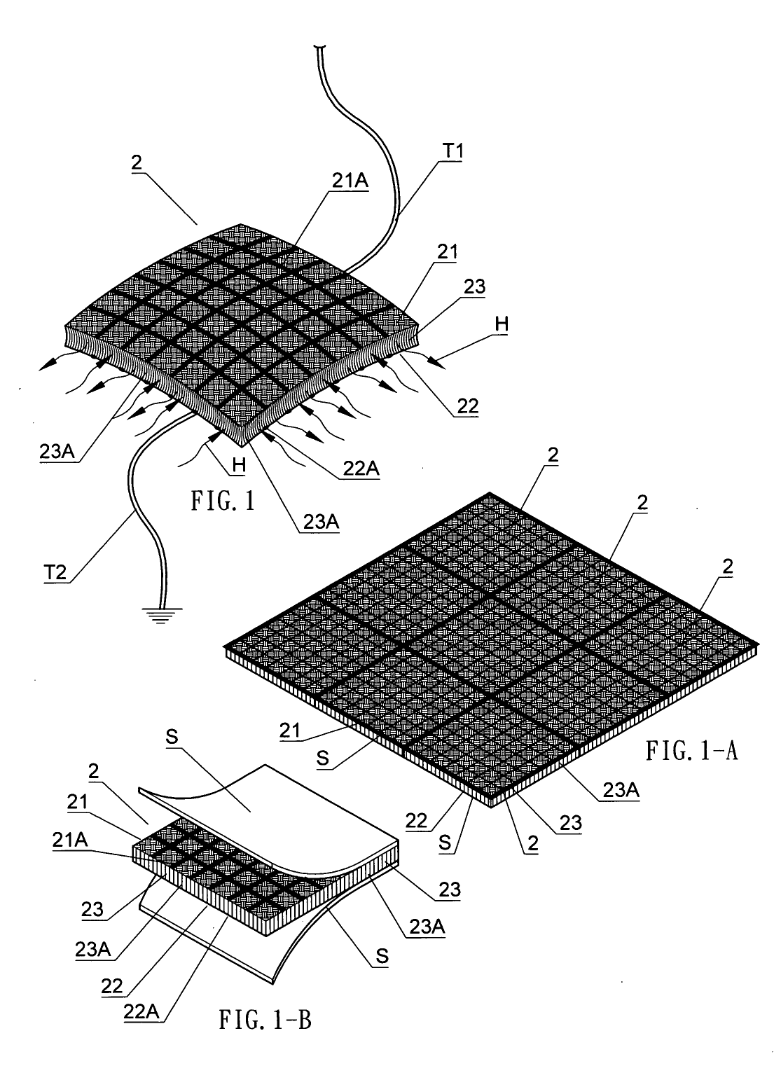

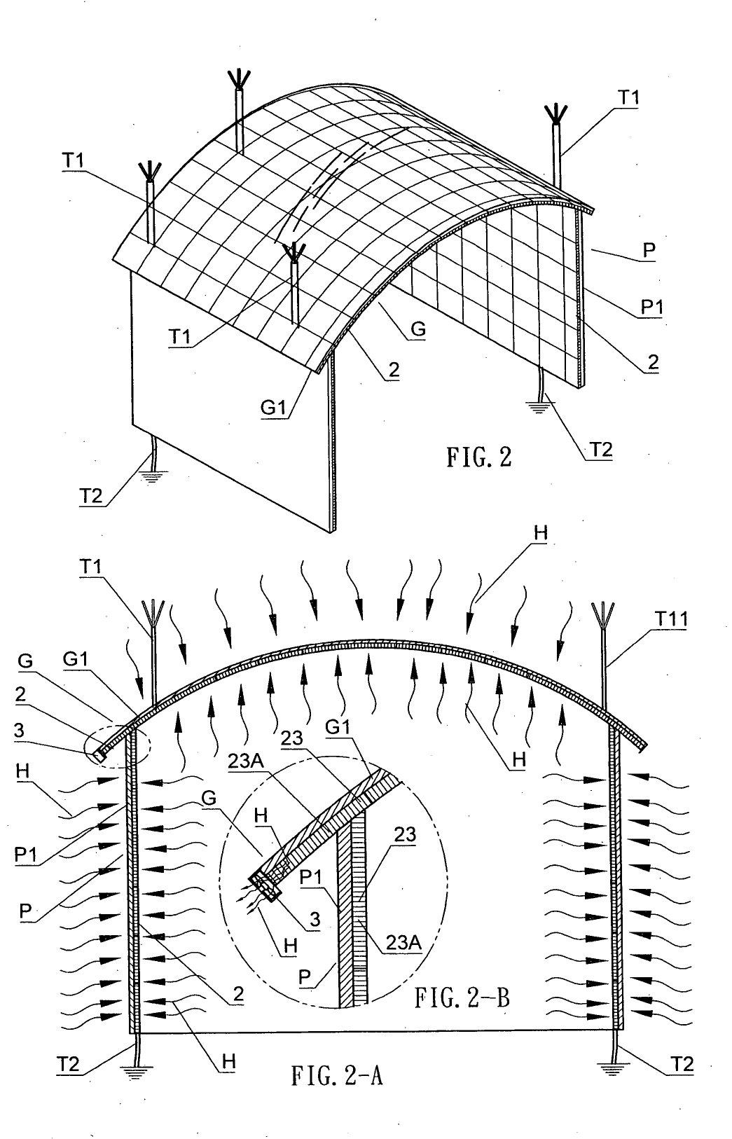

The disclosure of the structural embodiment and application of the invention herein is accompanied by the said drawings for reference; referring to FIG. 1 and FIG. 1-A, the invention herein consists of top and bottom, double-sided knit cloth surfaces 21 and 22 conjoined in the center section by numerous densely distributed, straightly arrayed, stiff, and supportive monofilament 23 into a pad 2 of a certain thickness, wherein since the cloth surfaces 21 and 22 and the supportive monofilament 23 have a suitable degree of flexibility, the pad 2 can be fashioned into a horizontal, arch-shaped ceiling G (see FIG. 2 and FIG. 2-A), or a straight horizontal ceiling, and a wall board serving as vertical wall surfaces P installed over interior layers that are curved or straight as per requirements, such that since there are aeration spaces 23A of similar density and fully distributed between the straightly arrayed and distributed monofilament 23 at the center section of the pad 2, these serve as hidden passageways for the outward discharge and dispersal of hot air currents H that accumulate inside the cloth surfaces 21 and 22.

As such, a liquid adhesive agent S (such as a sound absorbent agent, inflammable agent, or stitch bonding agent) is applied onto the exterior layer of the board cloth surfaces 21 and 22 as a treatment and after the adhesive agent S evenly permeates the weave crevices of the fabric and dries, since the fabric weave is filled-in, the cloth surfaces 21 and 22 harden into a board-like entity that provides for a horizontal ceiling G or a vertical wall surface P installed over interior layers (see FIG. 2 and FIG. 2-A)

Referring to FIG. 2 and FIG. 2-A, due to indoor heat mainly from the building cover board G1 lining the exterior layer of the ceiling G or the wall board P1 lining the exterior layer of the wall surface P as well as the effect of the increased temperature from the outdoor high temperature pad 2 along the exterior layer cloth surface 21 or the effect of indoor accumulation that increases the temperature of the interior layer cloth surface 22, the air current H accumulated in the aeration spaces 23A rise in temperature and become hot air currents.

At which time, after the top and the bottom of the double-sided pad 2 are no longer ventilatory, but the aeration spaces 23A between each strand of monofilament 23 remain in total continuity, and an air current exhaust/intake device 3 (such as an exhaust fan) is installed at outermost side of the pad 2 to force the circulation of the air current H in the pad 2 and enable its discharge and dispersal (see FIG. 2-A and FIG. 2-B); as such, the hot air currents H are continuously exhausted or drawn off, causing a temperature reduction effect at the cloth surface 21 along the exterior layer of the pad 2 as well as the cloth surface 22 along its interior layer, enabling a gradual decrease of indoor temperature until coolness and comfort is attained.

Additionally, since the knitting process of the pad 2 cloth surfaces 21 and 22 occurs simultaneously with the fabrication of the densely distributed, straightly arrayed, stiff, supportive monofilament 23 conjoining the center section and, furthermore, the cloth surfaces 21 and 22 are partially translucent, if translucent supportive monofilament 23 and the adhesive S is applied to the surface of the building cover board G1 lining the exterior layer of the ceiling G (such as in the translucent roof of a greenhouse) or the wall board P1 lining the exterior layer of the wall surface P have a matching material translucency or transparency, then dim conditions indoors can be effectively reduced, decreasing the need to use electrical lighting during the daytime and thereby effectively saving energy resources, which is among the major features of the invention herein.

Furthermore, since the knitting process of the pad 2 cloth surfaces 21 and 22 includes the simultaneous interweaving of conductive strands 21A and 22A that are fully or partially distributed and in continuity, the end or middle section of any conductive strand 21A and 22A provides for the connection of a lighting rod T1 and a ground wire T2 or a plurality of lighting rods T1 and ground wires T2 to form a full coverage electrical grounding wire network capable of dissipating sudden high voltage discharges when lightning strikes, thereby providing optimal protection (see FIG. 1 and FIG. 2) and demonstrably enhancing large-scale building safety, which are among the features of the invention herein.

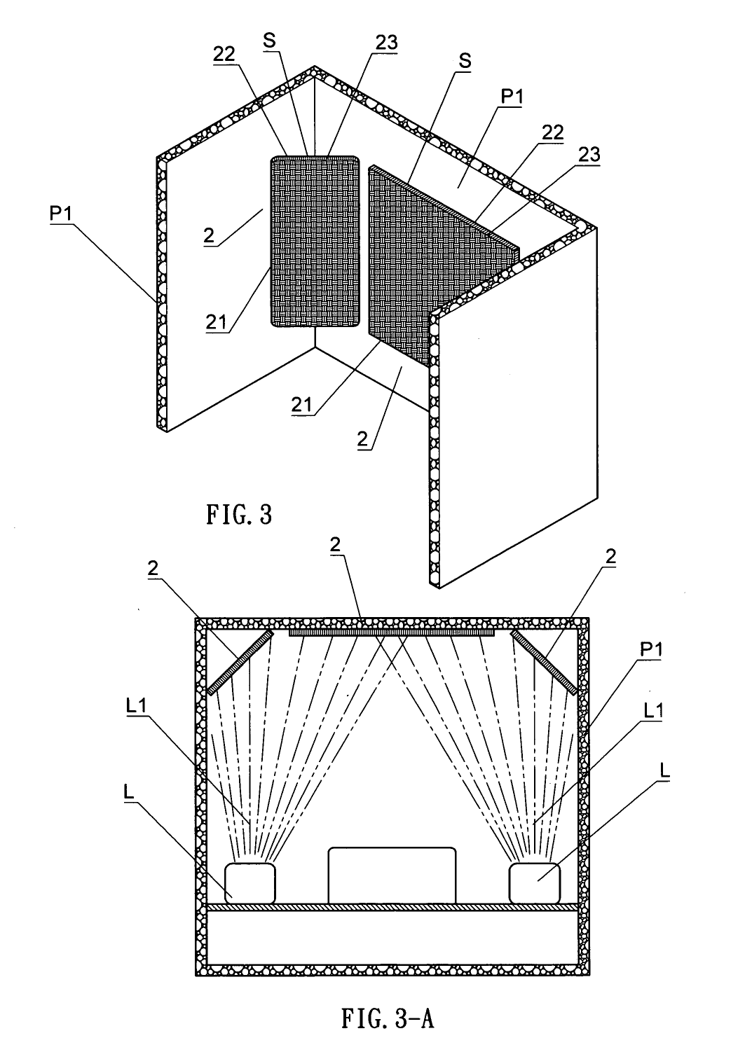

Referring to FIG. 3 and FIG. 3-A, an application of the pad 2 of the invention herein, since the knitted density of the cloth surfaces 21 and 22 absorb sound waves L1 generated by the speaker L and the structurally hollow damping space along the rear section of the supportive monofilament 23 retards sound waves, thereby preventing collision with vertical wall surfaces and random noise disturbance, it is optimal for utilization as an acoustically absorbent board and, furthermore, since a portion of the pad 2 can be installed as a separate and angled acoustically absorbent board attached to a wall surface or corner position, and used as an acoustically absorbent wall board or an acoustically absorbent panel, it can be optionally coated with the adhesive agent S such that its shape becomes solidified to effectively facilitate installation.

In summation of the foregoing section, since the structure of the invention herein provides for enhanced wall board having translucence, ventilation, temperature reduction, and other original capabilities, the present invention meets new patent application requirements.

1. A woven, lateral direction ventilated wall board structure consisting of top and bottom, double-sided knit cloth surfaces conjoined in the center section by numerous densely distributed, straightly arrayed, stiff, and supportive monofilament into a pad of a certain thickness, wherein since the said cloth surfaces and the said supportive monofilament have a suitable degree of flexibility, a stitch bonding liquid adhesive agent is applied onto the exterior layer of the said cloth surfaces and as a treatment and after the said adhesive agent evenly permeates the weave crevices of the fabric and dries, since the fabric weave is filled-in, the said cloth surfaces harden into a board-like entity that provides for a horizontal ceiling or a vertical wall surface installed over interior layers, which is among the features of the present invention.

2. As mentioned in claim 1 of the woven, lateral direction ventilated wall board structure of the invention herein, after the said cloth surfaces of the board structure are treated by the application of the said adhesive agent and are no longer ventilatory but aeration spaces between each strand of said monofilament remain in total continuity, an air current exhaust/intake device is installed at outermost side of the said pad to force the circulation of the air current in the said pad and enable its discharge and dispersal; as such, hot air currents are continuously exhausted or drawn off, causing a temperature reduction effect at the said cloth surface along the exterior layer of the said pad as well as the said cloth surface along its interior layer, enabling a gradual decrease of indoor temperature until coolness and comfort is attained, which is among the features of the present invention.

3. As mentioned in claim 1 of the woven, lateral direction ventilated wall board structure of the invention herein, since the said cloth surfaces are partially translucent, if translucent, supportive said monofilament and the said adhesive is applied to the surface of a building cover board lining the exterior layer of the said ceiling or a wall board lining the exterior layer of the said wall surface have a matching material translucency or transparency, then dim conditions indoors can be effectively reduced, decreasing the need to use electrical lighting during the daytime and thereby effectively saving energy resources, which is among the major features of the invention herein.

4. As mentioned in claim 1 of the woven, lateral direction ventilated wall board structure of the invention herein, since the knitting process of the said pad cloth surfaces includes the simultaneous interweaving of conductive strands and that are fully or partially distributed and in continuity, the end or middle section of any said conductive strand provides for the connection of a lighting rod and a ground wire or a plurality of said lighting rods and said ground wires to form a full coverage electrical grounding wire network capable of dissipating sudden high voltage discharges when lightning strikes, thereby providing optimal protection, which is among the features of the invention herein.
